(19) United States
(12) Patent Application Publication
(10) Pub. No.: US 2023/0418451 A1
(43) Pub. Date: Dec. 28, 2023

(54) OPERATION SUPPORT DEVICE, OPERATION SUPPORT METHOD, AND OPERATION SUPPORT PROGRAM

(71) Applicant: Nippon Telegraph and Telephone Corporation, Tokyo (JP)

(72) Inventors: Makoto KOMIYAMA, Musashino-shi, Tokyo (JP); Akira KATAOKA, Musashino-shi, Tokyo (JP); Hidetaka KOYA, Musashino-shi, Tokyo (JP)

(21) Appl. No.: 18/037,384

(22) PCT Filed: Nov. 17, 2020
(86) PCT No.: PCT/JP2020/042875

§ 371 Date: May 17, 2023

(51) Int. Cl. G06F 3/04847

(52) U.S. Cl. CPC G06F 3/04847; G06F 40/14

(57) ABSTRACT

An operation support device includes an acquisition unit configured to acquire information on a designated range based on operation of a user, an extraction unit configured to extract information on user interface (UI) elements included in the designated range from the information on the designated range acquired by the acquisition unit, a generation unit configured to generate a selector representing a search range including the designated range on a basis of the information on the UI elements extracted by the extraction unit, and a setting unit configured to set the search range from the selector representing the search range generated by the generation unit.

### TECHNICAL FIELD

The present invention relates to an operation support device, an operation support method, and an operation support program.

### BACKGROUND ART

In related art, in a general business system such as a web system, there is a user interface (UI) extension technique that achieves productivity improvement by adding a UI component having an input check function, an input automation function, and the like, without developing a target application itself (see, for example, Patent Literature 1).

In a display control scheme used in the UI extension technique, in a case where a UI element (base point UI) serving as a base point of display designated by a user is displayed on a screen, a UI component (extended UI) associated with the base point UI is displayed.

For example, in this display control scheme, even in a case where screen display is dynamically changed by processing such as scrolling of the display screen or clicking of the screen, display of the extended UIs is switched in accordance with whether or not the designated base point UI is displayed.

In order to cope with dynamic change of the screen UI as described above, the UI elements that can be the base point UI among the UI elements of the target screen are monitored, and display and hiding are updated on the basis of the UI elements. Thus, in display control, it is necessary to monitor UI elements that can match a display rule.

Here, there are the following two methods for setting the base point UI related to the display rule. The first method is “attribute designation” for specifying the base point UI from tag name, a text value, and the like, and enables comprehensive monitoring of UI elements that can be the base point UI. In the attribute designation, a UI not intended by the user is also set as a monitoring target, which may increase processing load.

The second method is “selector designation” for specifying the base point UI by a selector representing a hierarchical structure and enables setting of only a UI desired to be set as the base point as the monitoring target. In the selector designation, a UI is uniquely specified by one selector, so that it is necessary to set the selectors corresponding to the number of UIs to be monitored.

### CITATION LIST

### Patent Literature

Patent Literature 1: JP 2018-005344 A

### SUMMARY OF INVENTION

### Technical Problem

However, in related art, load of display processing of extended UIs is reduced, and thus, it has been impossible to easily set only an appropriate base point UI as the monitoring target. This is because, in setting of a display rule in related art, all the UI elements that can match the display rule on one screen are set as monitoring target UIs, and thus, a condition for filtering the monitoring target UIs, such as designating a range of the UI desired to be set as the monitoring target by the user, is additionally required.

On the other hand, a UI configuration of a web page is generally managed and handled with a document object model (DOM) tree, and information on the DOM tree does not intuitively match appearance and arrangement of actually displayed UIs. Thus, in the method in related art, it is difficult to select a UI element targeted by an unskilled user from the DOM tree, and in order to filter UIs to be monitored, it is necessary that information on the DOM tree is clear and the user has a skill to handle the DOM tree.

### Solution to Problem

In order to solve the above-described problems and achieve the object, an operation support device according to the present invention includes: an acquisition unit configured to acquire information on a designated range based on operation of a user; an extraction unit configured to extract information on UI elements included in the designated range from the information on the designated range acquired by the acquisition unit; a generation unit configured to generate a selector representing a search range including the designated range on the basis of the information on the UI elements extracted by the extraction unit; and a setting unit configured to set the search range from the selector generated by the generation unit.

Furthermore, an operation support method according to the present invention is an operation support method to be executed by an operation support device, the operation support method including: an acquisition process of acquiring information on a designated range based on operation of a user; an extraction process of extracting information on UI elements included in the designated range from the information on the designated range acquired by the acquisition unit; a generation process of generating a selector representing a search range including the designated range on the basis of the information on the UI elements extracted by the extraction unit; and a setting process of setting the search range from the selector generated by the generation unit.

In addition, an operation support program according to the present invention causes a computer to execute: an acquisition step of acquiring information on a designated range based on operation of a user; an extraction step of extracting information on UI elements included in the designated range from the information on the designated range acquired by the acquisition unit; a generation step of generating a selector representing a search range including the designated range on the basis of the information on the UI elements extracted by the extraction unit; and a setting step of setting the search range from the selector generated by the generation unit.

### Advantageous Effects of Invention

According to the present invention, load of display processing of extended UIs is reduced, so that it is possible to easily set only an appropriate base point UI as a monitoring target.

### BRIEF DESCRIPTION OF DRAWINGS

FIG. 1 is a block diagram illustrating a configuration example of an operation support device according to a first embodiment.

FIG. 2 is a view illustrating an example of flow of search range selector generation processing according to the first embodiment.

FIG. 3 is a view illustrating content of each search range selector generation pattern according to the first embodiment.

FIG. 4 is a view illustrating an example of flow of grouping processing according to the first embodiment.

FIG. 5 is a view illustrating an example of the flow of the search range selector generation processing and grouping processing according to the first embodiment.

FIG. 6 is a view illustrating an example of setting of a search range according to the first embodiment.

FIG. 7 is a view illustrating an example of setting of the search range according to the first embodiment.

FIG. 8 is a flowchart illustrating an example of flow of operation support processing according to the first embodiment.

FIG. 9 is a flowchart illustrating an example of flow of the grouping processing according to the first embodiment.

FIG. 10 is a view illustrating a computer that executes a program.

### DESCRIPTION OF EMBODIMENTS

An embodiment of an operation support device, an operation support method, and an operation support program according to the present invention will be described in detail below with reference to the drawings. Note that the present invention is not limited to the embodiment described below.

### First Embodiment

A configuration of an operation support device according to the present embodiment, a specific example of search range selector generation processing, grouping processing, and operation support processing, flow of the operation support processing, and flow of the grouping processing will be sequentially described below, and finally, effects of the present embodiment will be described.

[Configuration of Operation Support Device]

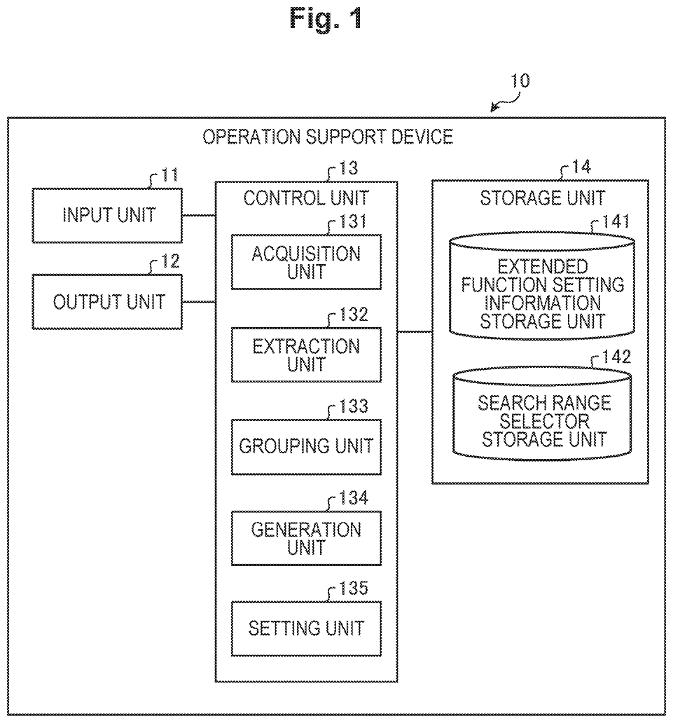

A configuration of an operation support device 10 according to the present embodiment will be described in detail with reference to FIG. 1. FIG. 1 is a block diagram illustrating a configuration example of an operation support device according to the present embodiment. The operation support device 10 includes an input unit 11, an output unit 12, a control unit 13, and a storage unit 14.

The input unit 11 controls inputting of various kinds of information to the operation support device 10. The input unit 11 is, for example, a mouse, a keyboard, or the like, and receives an input of setting information, or the like, to the operation support device 10. Further, the output unit 12 controls outputting of various kinds of information from the operation support device 10. The output unit 12 is, for example, a display, or the like, and outputs setting information, or the like, recorded in the operation support device 10.

The storage unit 14 stores various kinds of information to be referred to when the control unit 13 operates and various kinds of information acquired when the control unit 13 operates. The storage unit 14 includes, for example, an extended function setting information storage unit 141 and a search range selector storage unit 142. Here, the storage unit 14 is, for example, a semiconductor memory element such as a random access memory (RAM) and a flash memory, a storage device such as a hard disk and an optical disk, or the like. Note that while in the example in FIG. 1, the storage unit 14 is installed inside the operation support device 10, the storage unit 14 may be installed outside the operation support device 10 or may be installed as a plurality of storage units.

The extended function setting information storage unit 141 stores information for the operation support device 10 to display and update display of extended UIs. The extended function setting information storage unit 141 stores, for example, a display condition of the extended UIs, a display update scheme, information regarding screen capture, and the like.

The search range selector storage unit 142 stores a search range selector generated by a generation unit 134 of the control unit 13. In addition, the search range selector storage unit 142 stores a search range selector obtained by obtaining a logical sum (“OR” as appropriate) for each group by a setting unit 135 of the control unit 13. Furthermore, the search range selector storage unit 142 may also store information on a designated range acquired by an acquisition unit 131 of the control unit 13, information regarding grouping processing, information on UI elements extracted by an extraction unit 132 of the control unit 13, and the like.

The control unit 13 controls the entire operation support device 10. The control unit 13 includes the acquisition unit 131, the extraction unit 132, a grouping unit 133, the generation unit 134, and a setting unit 135. Here, the control unit 13 is, for example, an electronic circuit such as a central processing unit (CPU) and a micro processing unit (MPU), or an integrated circuit such as an application specific integrated circuit (ASIC) and a field programmable gate array (FPGA).

The acquisition unit 131 acquires information on a designated range based on operation of a user. Here, the operation of the user is operation of designating UI elements that the user desires to monitor. For example, the user designates a range of a rectangular region by mouse drag operation on part of values in a table on screen capture. Note that the operation of the user is not particularly limited as long as it is operation to designate the UI elements and may be operation using a touch pen, or the like, on a touch panel or operation using a voice recognition technology or a line-of-sight recognition technology in addition to operation using a mouse such as mouse click operation.

Furthermore, the information on the designated range is information regarding a position of a target range acquired on the basis of the operation of the user. For example, the acquisition unit 131 acquires information on a position and a size of the rectangular region designated by the user on the screen capture and determines target values in the rectangular region. Furthermore, the information on the designated range is not limited to information acquired by the user by mouse drag operation, or the like, and may be information designated by the user in advance or may be a condition set by the user in advance.

The extraction unit 132 extracts information on UI elements included in the designated range from the information on the designated range acquired by the acquisition unit 131. For example, the extraction unit 132 extracts hierarchy information of the UI elements as the information on the UI elements. Here, the information on the UI elements is information related to the UI components or operation of the UIs, attribute values including tag name or text values, hierarchy information for each UI element, or the like, but is not particularly limited and may be a condition set in advance by the user, or the like. Furthermore, the hierarchy information specifies a hierarchical structure of the UI elements such as a DOM tree structure and a hierarchical selector, but is not particularly limited. Furthermore, the hierarchical selector is represented by a set of information such as an attribute value such as tag name of the UI element and a child number of a child element as viewed from a parent element.

The grouping unit 133 groups the UI elements on the basis of the information on the UI elements extracted by the extraction unit 132. For example, the grouping unit 133 performs grouping on the basis of at least one of depths of the UI elements on the DOM tree, the attribute values or the condition set by the user. Here, the depth of the UI element on the DOM tree is, for example, the number of hierarchies from the root node, but is not particularly limited. The attribute value is, but is not particularly limited to, tag name such as “TBODY”, “TR”, and “TD”. Furthermore, the condition set by the user is, for example, information designating a UI element structure serving as a model of a monitoring target and a DOM tree, but is not particularly limited. The grouping processing will be described in detail later.

The generation unit 134 generates a selector representing a search range including the designated range on the basis of the information on the UI elements extracted by the extraction unit 132. For example, the generation unit 134 generates a selector representing a search range on the basis of the hierarchy information on the UI elements extracted by the extraction unit 132. Furthermore, in a case where the hierarchy information on the UI elements extracted by the extraction unit 132 includes a common term, the generation unit 134 generates a selector representing a search range of a UI element group including the common term. Furthermore, the generation unit 134 generates a selector representing a search range for each UI element group formed by the grouping unit 133. Further, the generation unit 134 stores a selector representing the generated search range in the search range selector storage unit 142.

The setting unit 135 sets a search range from the selector representing the search range generated by the generation unit 134. In addition, the setting unit 135 acquires the selector representing the search range from the search range selector storage unit 142. In addition, the setting unit 135 sets the search range from an OR of selectors representing the search ranges generated for each of the grouped UI element groups. Further, the setting unit 135 controls display of the extended UIs corresponding to the UI elements included in the search range by a predetermined scheme on the basis of the selector representing the search range generated by the generation unit 134. For example, the setting unit 135 can set hiding of the extended UIs corresponding to the UI elements included in the specific search range.

On the other hand, the setting unit 135 stores an OR of the selectors representing the search ranges generated for each grouped UI element group as a search range selector in the search range selector storage unit 142.

[Search Range Selector Generation Processing]

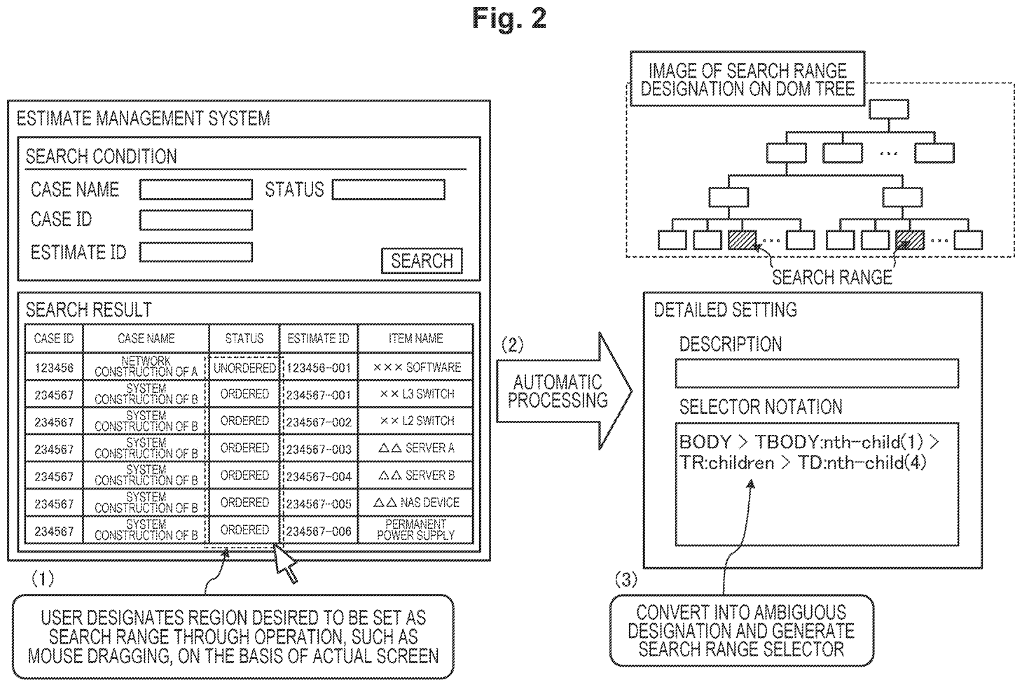

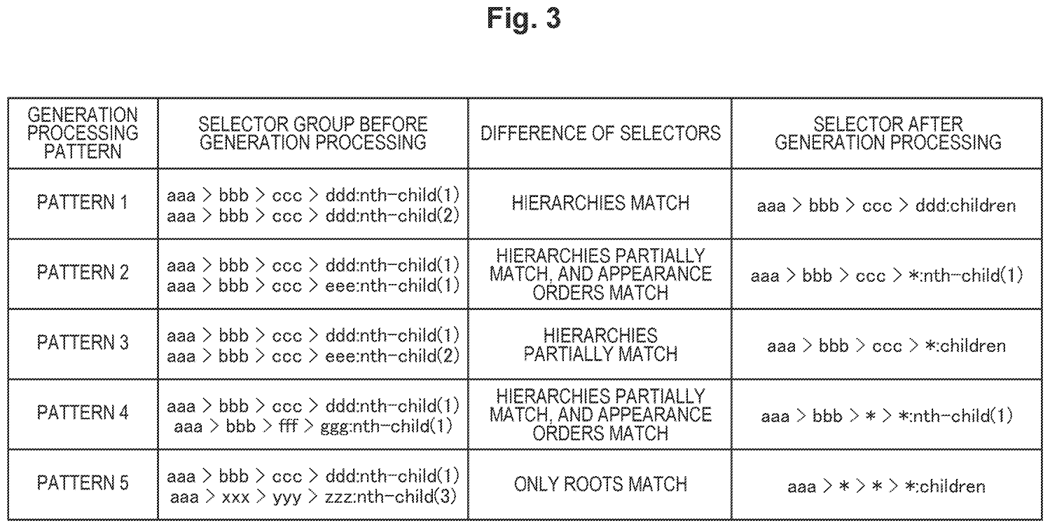

Search range selector generation processing according to the present embodiment will be described in detail with reference to FIGS. 2 and 3. FIG. 2 is a view illustrating an example of flow of the search range selector generation processing according to the first embodiment. Further, FIG. 3 is a view illustrating content of each search range selector generation pattern according to the first embodiment.

First, outline of the search range selector generation processing according to the present embodiment will be described with reference to FIG. 2. First, the user designates a region to be set as a search range by operation such as mouse drag on the basis of an actual screen of an editor, or the like (see (1) of FIG. 2). In FIG. 2, while a range surrounded by a rectangle is set as the designated range, it is only necessary that a closed range can be created using some means, and a range surrounded by a circle, an ellipse, a figure drawn by a free hand, or the like may be used.

Next, the operation support device 10 automatically lists UI elements entirely within the rectangular region as UIs to be monitored (see (2) in FIG. 2). In this event, the operation support device 10 can also list UI elements partially included in the rectangular region as UIs to be monitored. Then, the operation support device 10 converts a selector notation into ambiguous designation on the basis of the hierarchy information, or the like, of the UI elements included in the designated range and generates a search range selector (see (3) of FIG. 2).

Secondly, a search range selector generation pattern will be described with reference to FIG. 3. Note that, in FIG. 3, the search range selector generation pattern according to the present embodiment includes patterns 1 to 5, but is not particularly limited.

In pattern 1, a selector representing a search range including the entire child elements is generated from a selector group having the same hierarchies but different child elements. For example, two selectors of “aaa>bbb>ccc>ddd: nth-child (1)” and “aaa>bbb>ccc>ddd: nth-child (2)“are common except that child elements of”: nth-child (1)“and”: nth-child (2)” are different. Here, by converting the difference of the child elements into “: childen” and generating a selector of “aaa>bbb>ccc>ddd: childen”, the entire child elements can be set as the search range.

In pattern 2, a selector representing a search range including the entire elements is generated from a selector group having partially matching hierarchies and matching appearance orders. For example, two selectors of “aaa>bbb>ccc>ddd: nth-child (1)” and “aaa>bbb>ccc>eee: nth-child (1)” are common except that elements of “ddd” and “eee” are different. Here, by converting the difference of the elements into “*” and generating a selector of “aaa>bbb>ccc>*: nth-child (1)”, the entire elements can be set as the search range. Note that it is conceivable that pattern 2 is used in processing in which values in the table are set as the search range.

In pattern 3, a selector representing a search range including the entire elements and the entire child elements is generated from a selector group having partially matching hierarchies and different child elements. For example, two selectors of “aaa>bbb>ccc>ddd: nth-child (1)” and “aaa>bbb>ccc>eee: nth-child (2)” are common except that “ddd: nth-child (1)” and “eee: nth-child (2)” are different. Here, by converting the difference of the elements into “*”, converting the difference of the child elements into “: childen”, and generating a selector of “aaa>bbb>ccc>*: childen”, the entire elements and the entire child elements can be set as the search range.

In pattern 4, a selector representing a search range including the entire elements is generated from a selector group having partially matching hierarchies and matching appearance orders. For example, two selectors of “aaa>bbb>ccc>ddd: nth-child (1)” and “aaa>bbb>fff>ggg: nth-child (1)” are common except that “ccc>ddd” and “fff>ggg” are different. Here, by converting the difference of the element into “*” and generating a selector of “aaa>bbb>*>*: nth-child (1)”, the entire elements can be set as the search range. Note that it is conceivable that pattern 4 is used in processing of setting values of a complicated table as the search range.

In pattern 5, a selector representing a search range including the entire elements and the entire child elements is generated from a selector group in which only root nodes on DOM trees match. For example, two selectors of “aaa>bbb>ccc>ddd: nth-child (1)” and “aaa>xxx>yyy>zzz: nth-child (3)” are all different except for “aaa”. Here, by converting the difference of the elements into “*”, converting the difference of the child elements into “: childen”, and generating a selector of “aaa>*>*>*: childen”, the entire elements and the entire child elements can be set as the search range. Note that, as in pattern 5, in a case where designation is ambiguous for all of a certain hierarchy and subsequent hierarchies, a selector such as “aaa: childen” may be generated.

[Grouping Processing]

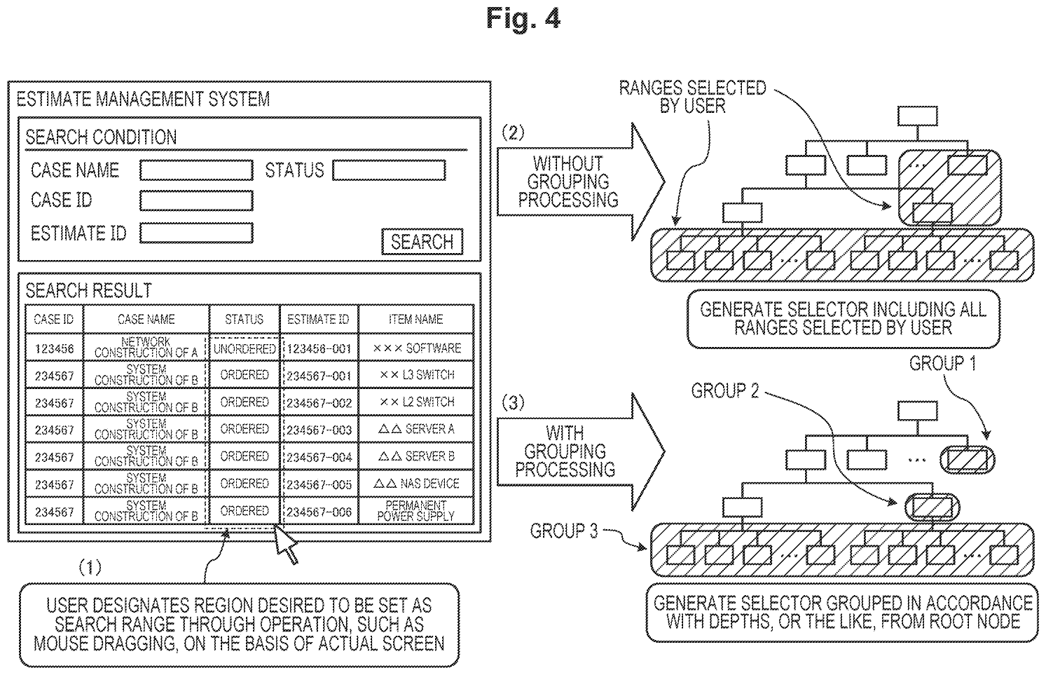

Grouping processing according to the present embodiment will be described in detail with reference to FIG. 4. FIG. 4 is a view illustrating an example of flow of the grouping processing according to the first embodiment. First, the user designates a region to be set as a search range by operation such as mouse drag on the basis of an actual screen of an editor, or the like (see (1) of FIG. 4).

Next, in a case where grouping is not necessary, the operation support device 10 does not perform grouping processing and performs search range selector generation processing (see (2) of FIG. 4). For example, in a case where the hierarchical selector group includes two selectors of “aaa>bbb>ccc>ddd: nth-child (1)” and “aaa>bbb>ccc>ddd: nth-child (2)” (see pattern 1 in FIG. 3), the operation support device 10 does not perform the grouping processing and generates a search range selector of “aaa>bbb>ccc>ddd: childen”, because the hierarchies match, and thus, grouping is not necessary.

Furthermore, in a case where it is set not to perform grouping, the operation support device 10 does not perform the grouping processing and performs the search range selector generation processing (see (2) in FIG. 4). For example, in a case where the hierarchical selector group includes two selectors of “aaa>bbb>ccc>ddd: nth-child (1)” and “aaa>xxx>yyy>zzz: nth-child (3)” (see pattern 5 in FIG. 3), all the selectors except the root node are different, and thus, when the grouping processing is not performed, the operation support device 10 generates a search range selector of “aaa>*>*>*: childen” or “aaa: childen”. In this event, the operation support device 10 generates a selector including all the UI elements in the range selected by the user.

On the other hand, in a case where grouping can be performed and it is set to perform grouping, the operation support device 10 performs grouping processing and then performs the search range selector generation processing (see (3) in FIG. 4). In this event, the operation support device 10 performs grouping according to depths of the UI elements on the DOM tree, attribute values, a condition set by the user, and the like.

For example, in a case where the depths of the UI elements in the range selected by the user on the DOM tree are different, the operation support device 10 performs grouping for each depth. In FIG. 4, there are three UI elements of the range selected by the user or UI element groups having different depths (the number of hierarchies) from the root node. Thus, the operation support device 10 groups UI elements with a depth of 1 from the root node as “group 1”, UI elements with a depth of 2 as “group 2”, and UI elements with a depth of 3 as “group 3” and generates a search range selector for each group.

The grouping processing described above is processing for preventing loss of a common term of hierarchical selectors by performing grouping before generating selectors and then comparing the respective selectors. In other words, when the user designates UI elements to be monitored, there is a possibility that the extracted UIs are interspersed on the DOM tree although the user is not conscious. In this event, if the grouping processing is not performed, the search range selector including all the UI elements is easily generated, which decreases a filtering effect.

Here, by performing the grouping processing, the search range selector can be generated for each appropriate group, and accuracy of filtering can be improved. Furthermore, by setting information (depths, attribute values, a hierarchical selector of a UI serving as a sample, and the like) on a sample of UIs desired to be a monitored by the user as a condition set by the user, it is possible to further improve the accuracy of filtering.

[Specific Example of Operation Support Processing]

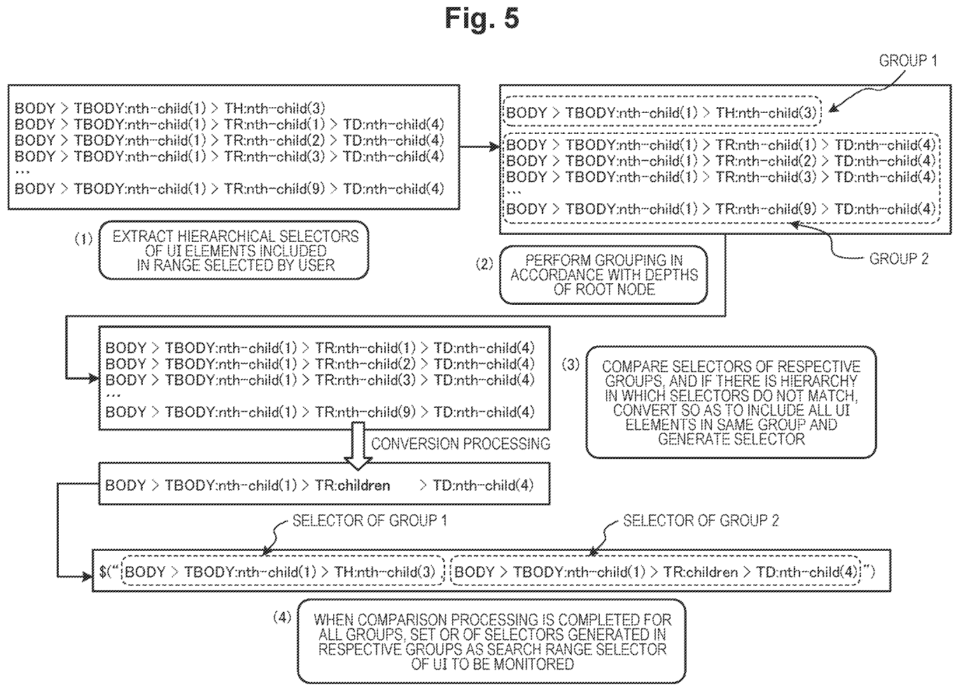

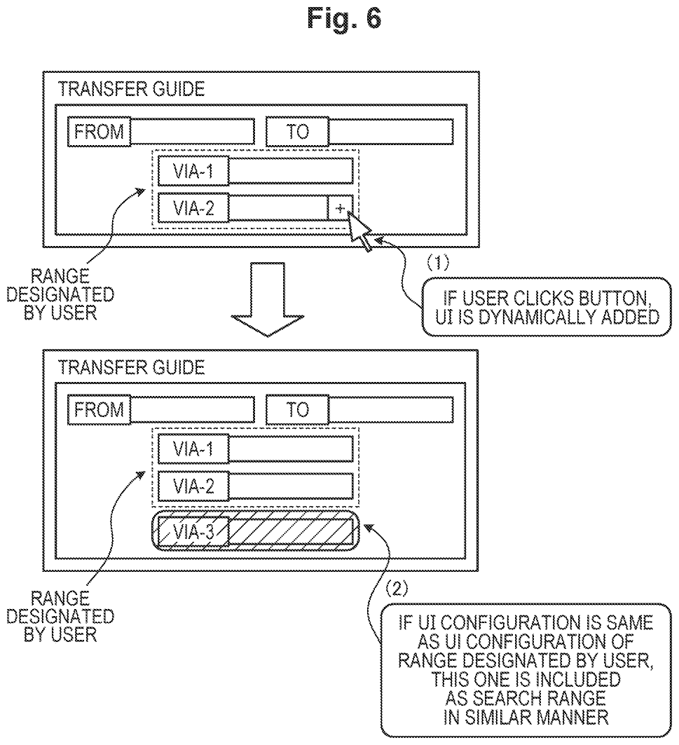

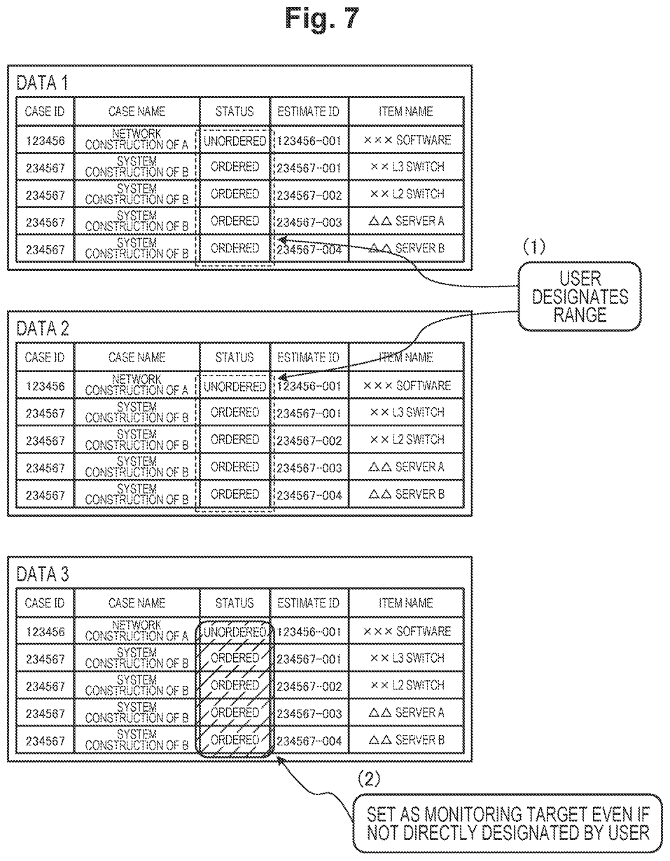

A specific example of the operation support processing according to the present embodiment will be described with reference to FIGS. 5 to 7. FIG. 5 is a view illustrating an example of flow of the search range selector generation processing and the grouping processing according to the first embodiment. FIGS. 6 and 7 are views illustrating an example of setting of the search range according to the first embodiment.

### Specific Example 1

First, an example of flow of the search range selector generation processing and the grouping processing according to the present embodiment will be described with reference to FIG. 5. First, the operation support device 10 extracts hierarchical selectors of UI elements included in the range selected by the user (see (1) in FIG. 5). Next, the operation support device 10 performs grouping in accordance with the depths from the root node of the DOM tree (see (2) in FIG. 5). In FIG. 5, the operation support device 10 can group the UI elements into group 1 and group 2 on the basis of a difference in depth of the lowermost node. In this event, the operation support device 10 may group the UI elements on the basis of the attribute values or the condition set by the user.

Subsequently, the operation support device 10 compares the selectors in each group, and if there is a hierarchy in which the selectors do not match, the selector is converted to include all the UI elements of the same group to generate the selector (see (3) of FIG. 5). In FIG. 5, only one selector is included in group 1, and thus, the subsequent conversion processing is not performed. On the other hand, group 2 includes a plurality of selectors, and thus, conversion processing is performed.

Specifically, in order to include all the different child numbers of “TR: nth-child (1)”, “TR: nth-child (2)”, “TR: nth-child (3)”, . . . , and “TR: nth-child (9)” of the selectors included in group 2, the operation support device 10 converts the child numbers into “TR: children” representing the entire child elements to generate the selector.

Finally, when the comparison processing is completed in all the groups, the operation support device 10 sets an OR of the selectors generated in the respective groups as the search range selector of the UI to be monitored (see (4) of FIG. 5).

### Specific Example 2

Secondly, a search range of UIs to be dynamically added will be described as an example of setting of the search range according to the present embodiment with reference to FIG. 6. In the search range selector generation processing according to the present embodiment, a non-common portion of the hierarchical selector is converted so as to include all the UI elements, so that, it is also possible to cope with a UI that does not appear at the beginning when the search range is set.

Specifically, in FIG. 6, a range initially designated by the user is only “via-1” and “via-2”. However, in a case where it is set such that another UI is dynamically added when the user clicks a button (see (1) of FIG. 6), “via-3” after the UI is added is similarly included as the search range if a UI configuration is the same as a UI configuration of the range designated by the user (see (2) of FIG. 6).

### Specific Example 3

Third, as an example of setting of the search range according to the present embodiment, a search range when there are a plurality of configurations of the same UI in the screen will be described with reference to FIG. 7. For example, it is also possible to cope with a case where a screen has a plurality of tables in the same page, data in each table is different, but there is data such as a partially common status and error code, and it is desired to set the data in a range to be monitored.

Specifically, in FIG. 7, the range initially designated by the user is a partial range of the tables “Data 1” and “Data 2” (see (1) in FIG. 7). However, as long as “data 3” has the same UI configuration as the UI configuration of the range designated by the user, even if the user does not directly designate “data 3”, the generated search range selector is converted into the designation including all UIs except for the common term, and thus, “data 3” is similarly included as the search range (see (2) in FIG. 7).

[Flow of Operation Support Processing]

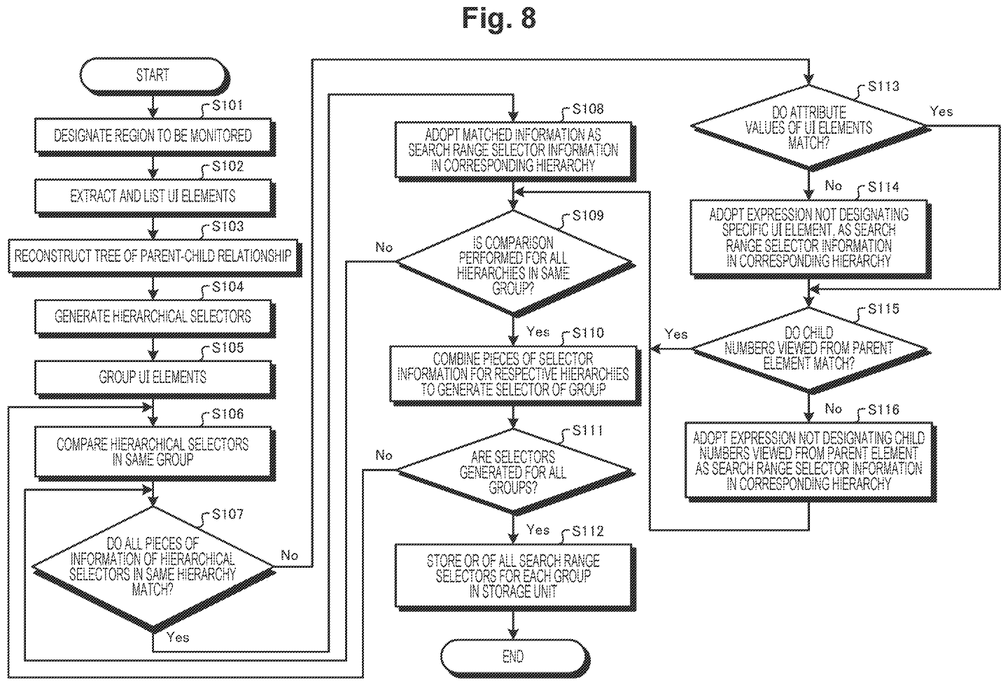

Flow of operation support processing according to the present embodiment will be described in detail with reference to FIG. 8. FIG. 8 is a flowchart illustrating an example of flow of the operation support processing according to the first embodiment. First, the operation support device 10 designates a region to be monitored on the basis of operation of the user (step S101). In this event, the user designates a region to be monitored on the basis of capture of a target screen read from extended function setting information stored in the storage unit 14.

Next, the operation support device 10 extracts and lists all the UI elements entirely within the region designated by the user (step S102). Furthermore, among the extracted UI elements, a DOM tree is reconstructed with those having a parent-child relationship (step S103). Then, a hierarchical selector is generated for each of the extracted UI elements or UI elements at the ends (children) of the reconstructed DOM tree (step S104). Note that order of the processing from step S102 to S104 is an example, and the operation support device 10 can perform the processing in different order. In addition, the operation support device 10 can omit part of processing from step S102 to S104.

Subsequently, the operation support device 10 groups the extracted UI elements according to one or all of the depths from the root nodes in the DOM tree, the attribute values of the UI elements, and the condition set in advance by the user (step S105). In this event, the operation support device 10 may group the UI elements at the ends (children) of the DOM tree reconstructed in step S103. Note that the operation support device 10 can omit the processing in step S105.

Then, the operation support device 10 compares the hierarchical selectors corresponding to the UI elements of the same group (step S106). In this event, in a case where all the pieces of information on the hierarchical selectors in the same hierarchy match (step S107: Yes), the operation support device 10 adopts the matched information as the information on the search range selector in the corresponding hierarchy (step S108).

On the other hand, in a case where the pieces of information on the hierarchical selectors in the same hierarchy do not match (step S107: No), the operation support device 10 converts the selectors. First, the operation support device 10 compares the attribute values of the UI elements, and in a case where the attribute values of the UI elements in the same hierarchy do not match (step S113: No), “*” or the like, which is an expression not designating a specific UI element, is adopted as the information on the search range selector in the corresponding hierarchy (step S114). In a case where the attribute values of the UI elements in the same hierarchy match (step S113: Yes), the operation support device 10 omits the processing in step S114.

Furthermore, the operation support device 10 compares child elements of UI elements in the same hierarchy, and in a case where child numbers viewed from the parent element do not match (step S115: No), “: children” or the like, which is an expression not designating a child number viewed from the parent element, is adopted as the search range selector information in the corresponding hierarchy (step S116). In a case where the child numbers viewed from the parent element in the same hierarchy match (step S115: Yes), the operation support device 10 omits the processing in step S116.

Thereafter, in a case where comparison is performed for all the hierarchies in the same group (step S109: Yes), the operation support device 10 combines the pieces of information on the search range selectors adopted for the respective hierarchies to generate the search range selector in the group (step S110). On the other hand, in a case where there is a hierarchy that has not been compared with the hierarchies in the same group (step S109: No), the processing of the operation support device 10 returns to step S107.

Finally, in a case where the operation support device 10 generates the search range selectors of the UI to be monitored for all the groups (step S111: Yes), the operation support device 10 sets, as the search range, one obtained by OR of all the search range selectors generated for respective groups (step S112), and the processing ends. On the other hand, in a case where there is a group for which the search range selector of the UI to be monitored has not been generated (step S111: No), the processing of the operation support device 10 returns to step S106. Note that the operation support device 10 may perform display control such as determination as to whether or not to display the extended UIs on the basis of the information on the generated search range selector. Furthermore, the operation support device 10 may perform display control such as change of a display scheme or an update scheme of the extended UIs on the basis of the information on the generated search range selector.

[Flow of Grouping Processing]

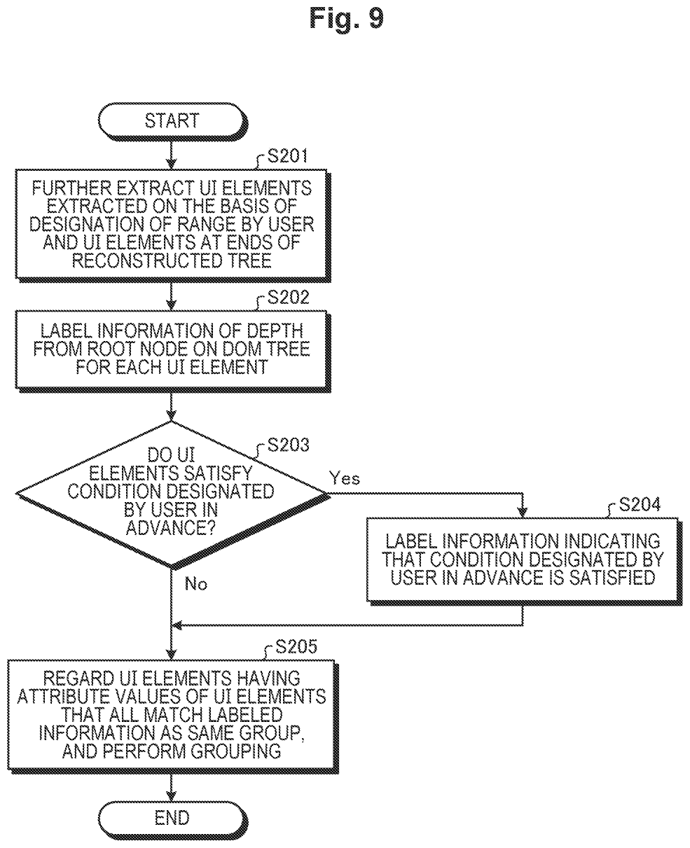

Flow of the grouping processing according to the present embodiment will be described in detail with reference to FIG. 9. FIG. 9 is a flowchart illustrating an example of flow of the grouping processing according to the first embodiment. First, the operation support device 10 further extracts UI elements extracted on the basis of designation of the region by the user (see step S102 in FIG. 8) and UI elements at the ends of the reconstructed DOM tree (see step S103 in FIG. 8) (step S201).

Next, the operation support device 10 labels each UI element with depth information from the root node on the DOM tree (step S202). Subsequently, in a case where the UI elements satisfy the condition designated in advance by the user (step S203: Yes), the operation support device 10 labels information indicating that the UI elements satisfy the condition designated in advance by the user (step S204). On the other hand, in a case where the UI elements do not satisfy the condition designated in advance by the user (step S203: No), the operation support device 10 omits the processing in step S204.

Finally, the operation support device 10 regards UI elements in which all the labeled information and the attribute values of the UI elements match as the same group, groups the UI elements (step S205) and ends the processing.

### Effects of First Embodiment

First, in operation support processing according to the present embodiment described above, information on a designated range based on operation of a user is acquired, information on UI elements included in the designated range is extracted from the acquired information of the designated range, a selector representing a search range including the designated range is generated on the basis of the extracted information on the UI elements, and the search range is set from the selector representing the generated search range. Thus, load of display processing of extended UIs is reduced, so that only an appropriate base point UI can be easily set as a monitoring target.

Second, in the operation support processing according to the present embodiment described above, hierarchy information of UI elements is extracted as information on the UI elements, and a selector representing a search range is generated on the basis of the extracted hierarchy information of the UI elements. Thus, the load of the display processing of the extended UIs is reduced, so that only an appropriate base point UI can be effectively set as the monitoring target.

Third, in the operation support processing according to the present embodiment described above, in a case where a common term is included in the hierarchy information of the extracted UI elements, a selector representing a search range of a UI element group including the common term is generated. Thus, the load of the display processing of the extended UIs is reduced, so that only an appropriate base point UI can be easily and efficiently set as the monitoring target.

Fourth, in the operation support processing according to the present embodiment described above, the UI elements are grouped on the basis of the information on the extracted UI elements, and a selector representing a search range is generated for each of the grouped UI element groups. Thus, the load of the display processing of the extended UIs is reduced, so that only an appropriate base point UI can be easily set as the monitoring target even if the hierarchy information is complicated.

Fifth, in the operation support processing according to the present embodiment described above, grouping is performed on the basis of at least one of depths of the UI elements on the DOM tree, attribute values, or a condition set by the user. Thus, the load of the display processing of the extended UIs is reduced, so that only an appropriate base point UI can be effectively and easily monitored even if the hierarchy information is complicated.

Sixth, in the operation support processing according to the present embodiment described above, display of extended UIs corresponding to the UI elements included in the search range is controlled by a predetermined scheme on the basis of the generated selector representing the search range. Thus, the load of the display processing of the extended UIs is further reduced, so that only an appropriate base point UI can be more easily set as the monitoring target.

[System Configuration Etc.]

Each component of each device that has been illustrated according to the embodiment described above is functionally conceptual and does not necessarily have to be physically configured as illustrated. In other words, a specific form of distribution and integration of individual devices is not limited to the illustrated form, and all or part of the configuration can be functionally or physically distributed and integrated in any unit according to various loads, usage conditions, and the like. Furthermore, all or any part of each processing function performed in each device can be implemented by a CPU and a program to be analyzed and executed by the CPU or can be implemented as hardware by wired logic.

Further, among the individual processing described in the embodiment described above, all or part of the processing described as being automatically performed can be manually performed, or all or part of the processing described as being manually performed can be automatically performed by a known method. In addition, processing procedures, control procedures, specific name, and information including various data and parameters illustrated in the specification and the drawings can be arbitrarily changed unless otherwise specified.

[Program]

In addition, it is also possible to create a program in which the processing to be executed by the operation support device 10 described in the embodiment described above is described in a language that can be executed by a computer. In this case, the computer executes the program, and thus, the effects similar to those of the embodiment described above can be obtained. Further, the program may be recorded in a computer-readable recording medium, and the program recorded in the recording medium may be read and executed by the computer. Thereby, processing similar to the embodiment described above may be realized.

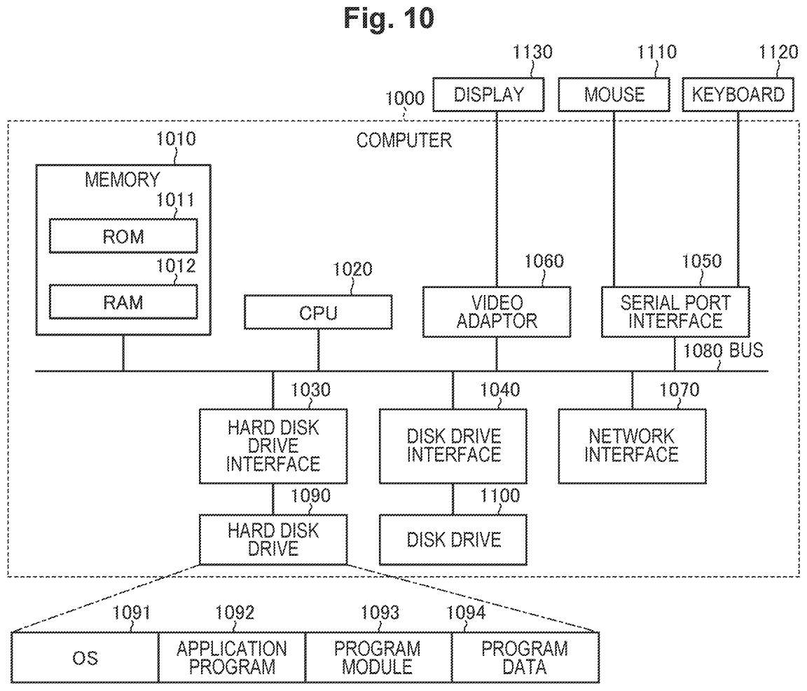

FIG. 10 is a view illustrating a computer that executes a program. As exemplified in FIG. 10, a computer 1000 includes, for example, a memory 1010, a CPU (central processing unit) 1020, a hard disk drive interface 1030, a disk drive interface 1040, a serial port interface 1050, a video adapter 1060, and a network interface 1070, and these individual units are connected by a bus 1080.

As exemplified in FIG. 10, the memory 1010 includes a read only memory (ROM) 1011 and a RAM 1012. The ROM 1011 stores, for example, a boot program such as a BIOS (basic input output system). The hard disk drive interface 1030 is connected to a hard disk drive 1090 as exemplified in FIG. 10. The disk drive interface 1040 is connected to a disk drive 1100 as exemplified in FIG. 10. For example, a removable storage medium such as a magnetic disk and an optical disk is inserted into the disk drive 1100. As exemplified in FIG. 10, the serial port interface 1050 is connected to, for example, a mouse 1110 and a keyboard 1120. As exemplified in FIG. 10, the video adapter 1060 is connected to, for example, a display 1130.

Here, as exemplified in FIG. 10, the hard disk drive 1090 stores, for example, an OS 1091, an application program 1092, a program module 1093, and program data 1094. In other words, the above program is stored, for example, in the hard disk drive 1090 as a program module in which a command to be executed by the computer 1000 is described.

Further, various data described in the embodiment described above is stored as program data in, for example, the memory 1010 and the hard disk drive 1090. Then, the CPU 1020 reads out the program module 1093 and the program data 1094 stored in the memory 1010 and the hard disk drive 1090 to the RAM 1012 as necessary and executes various processing procedures.

Note that the program module 1093 and the program data 1094 related to the program are not limited to being stored in the hard disk drive 1090 and may be stored in, for example, a removable storage medium and may be read by the CPU 1020 via a disk drive, or the like. Alternatively, the program module 1093 and the program data 1094 related to the program may be stored in another computer connected via a network (such as a local area network (LAN) or a wide area network (WAN)) and may be read by the CPU 1020 via the network interface 1070.

The embodiment described above and modifications thereof are included in the inventions recited in the claims and the equivalent scope thereof, similarly to being included in the technique disclosed in the present application.

### REFERENCE SIGNS LIST

10 Operation support device
11 Input unit
12 Output unit
13 Control unit
131 Acquisition unit
132 Extraction unit
133 Grouping unit
134 Generation unit
135 Setting unit
14 Storage unit
141 Extended function setting information storage unit
142 Search range selector storage unit

1. An operation support device comprising:
an acquisition unit, implemented using one or more computing devices, configured to acquire information regarding a designated range based on operation of a user;
an extraction unit, implemented using one or more computing devices, configured to extract information regarding user interface (UI) elements included in the designated range from the acquired information regarding the designated range;
a generation unit, implemented using one or more computing devices, configured to generate a selector representing a search range including the designated range based on the information regarding the UI elements; and
a setting unit, implemented using one or more computing devices, configured to set the search range from the generated selector.

2. The operation support device according to claim 1, wherein;
the extraction unit is configured to extract hierarchy information of the UI elements as the information regarding the UI elements, and
the generation unit is configured to generate the selector based on the hierarchy information.

3. The operation support device according to claim 2, wherein the generation unit is configured to, based on the hierarchy information including a common term, generate a selector representing a search range of a UI element group including the common term.

4. The operation support device according to claim 1, further comprising:
a grouping unit, implemented using one or more computing devices, configured to group the UI elements based on the extracted information regarding the UI elements,
wherein the generation unit is configured to generate the selector for each UI element group formed by the grouping unit.

5. The operation support device according to claim 4, wherein the grouping unit is configured to group the UI elements based on at least one of depths of the UI elements on a document object model (DOM) tree, attribute values, or a condition set by a user.

6. The operation support device according to claim 1, wherein the setting unit is configured to control display of extended UIs corresponding to the UI elements included in the search range using a predetermined scheme based on the selector generated by the generation unit.

7. An operation support method to be executed by an operation support device, the method comprising:
acquiring information regarding a designated range based on operation of a user;
extracting information regarding UI elements included in the designated range from the acquired information regarding the designated range;
generating a selector representing a search range including the designated range based on the information regarding the UI elements; and
setting the search range from the generated selector.

8. A non-transitory computer-readable medium storing an operation support program, wherein execution of the operation support program causes one or more computers to perform operations comprising:
acquiring information regarding a designated range based on operation of a user;
extracting information regarding UI elements included in the designated range from the acquired information regarding the designated range;
generating a selector representing a search range including the designated range based on the information regarding the UI elements; and
setting the search range from the generated selector.
